(19) United States
(12) Patent Application Publication
(10) Pub. No.: US 2025/0117228 A1
(43) Pub. Date: Apr. 10, 2025

(54) DIFFERENTIAL INDIVIDUAL TENANT RUNTIME EXPERIENCE IN A MULTI-TENANT PLATFORM

(71) Applicant: Walmart Apollo, LLC, Bentonville, AR (US)

(72) Inventors: Anshuman Sinha, Bengaluru (IN); Arun George, Bangalore (IN); Somya Iyer, Bengaluru (IN)

(21) Appl. No.: 18/883,774

(22) Filed: Sep. 12, 2024

Related U.S. Application Data
(60) Provisional application No. 63/588,381, filed on Oct. 6, 2023.

(51) Int. Cl. G06F 9/445

(52) U.S. Cl. CPC G06F 9/4451

(57) ABSTRACT

This application is directed to systems and methods for executing a user application on a multi-tenant service platform. In some embodiments, a disclosed method includes obtaining, from a user, a request associated with a first division in a user application; identifying an operation policy associated with a configuration of the user application for the first division, the user application including a plurality of executors configured to provide a plurality of parameters associated with the configuration; based at least in part on the operation policy of the first division, selecting one of the plurality of executors to respond to the request associated with the first division; executing the user application using the selected one of the plurality of executors to generate a response to the request associated with the first division; and transmitting the response to the request associated with the first division to the user.

### CROSS-REFERENCE TO RELATED APPLICATION

This application claims benefit to U.S. Provisional Application Ser. No. 63/588,381, entitled “Differential Individual Tenant Runtime Experience in a Multi-Tenant Platform,” filed on Oct. 6, 2023, the disclosure of which is incorporated herein by reference in its entirety.

### TECHNICAL FIELD

This application relates generally to computer technology and, more particularly, to systems and methods for implementing a user application for a plurality of tenants on a cloud-based service platform.

### BACKGROUND

Multitenancy allows multiple users or client organizations to share a single physical computer or virtual machine, or a software application deployed on a set of physical computers or virtual machines and helps reduces a cost of information technology (IT) infrastructure for hosting user applications. Multitenancy is applicable at different levels of abstraction (e.g., hardware, operating system, application, or database). In the context of cloud computing, multitenancy enables cloud providers to reduce operational costs by sharing underlying resources across different users and client organizations and to simplify application management and maintenance by having common infrastructure and practices. Cost efficiency for executing the user application is greatly enhanced by way of an application-level multitenancy. However, with multitenancy, each tenant's options are restricted at best to a predefined service rate or quota of the user application. This compels a tenant to consume what is available, which in turn impacts expenses, quality of service, and user satisfaction. Specifically, existing multitenant systems have predefined service settings which leads to higher cost of consumption, lack of flexibility, lower customer satisfaction, and unnecessary operational and support overhead from a service providers side to meet Service Level Agreements (SLA). It is desirable to have a cloud-based multi-tenant service platform that executes an associated user application efficiently and with high customer satisfaction.

### BRIEF DESCRIPTION OF THE DRAWINGS

The features and advantages of the present disclosure will be more fully disclosed in, or rendered obvious by the following detailed description of the example embodiments, which are to be considered together with the accompanying drawings wherein like numbers refer to like parts and further wherein:

FIG. 1 is a network environment configured to provide a user application to a plurality of tenants, in accordance with some embodiments of the present teaching.

FIG. 2A is a block diagram of a computing device, in accordance with some embodiments of the present teaching.

FIGS. 2B and 2C are structures of instructions and data stored in memory of a computing device, in accordance with some embodiments of the present teaching.

FIG. 3A illustrates example sources of division information applied to determine operation policies for each of a plurality of divisions, in accordance with some embodiments of the present teaching.

FIG. 3B illustrates an example process of setting operation policies for a plurality of divisions, in accordance with some embodiments of the present teaching.

FIG. 4 is a block diagram of an example user application implemented for a plurality of divisions in response to associated requests, in accordance with some embodiments of the present teaching.

FIG. 5 a block diagram of an example user application dynamically implemented by a computing device, in accordance with some embodiments of the present teaching.

FIG. 6 a block diagram of an example user application implemented for a first division, in accordance with some embodiments of the present teaching.

FIG. 7 a block diagram of an example user application implemented with scheduling management for a first division, in accordance with some embodiments of the present teaching.

FIG. 8 a block diagram of an example user application implemented for two divisions based on different current parameters or operation policies of the two divisions, in accordance with some embodiments of the present teaching.

FIG. 9 is a flowchart illustrating an example method for executing a user application for a plurality of divisions based on respective operation policies, in accordance with some embodiments of the present teaching.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

Various embodiments described herein are directed to systems and methods for dynamically supporting a plurality of tenants (e.g., divisions, departments, users, or client organizations) based on respective policy operations associated with configurations of a user application in a cloud-based service platform or system. Such a multi-tenant system is associated with a service provider and includes a plurality of individually deployed enterprise class business components (e.g., executors, notifier, controller, orchestrator). The components of the multi-tenant system are configured to cater to all of the plurality of tenants and provide differential experience to each tenant based on a subscription of a respective tenant. The system synergizes across the plurality of components to meet a subscription agreement between the service provider and each tenant. In some embodiments, a synergy among the components of the system is achieved using respective operation policies that are managed in a standard schema for the plurality of tenants. An operation policy associated with a tenant is exchanged between a tenant and the service provider either statically at a start-up time or dynamically during a run time. In some embodiments, a self-learning module is used for continual learning and adaption of configurations and operation policies based on real time attributes. Additionally, a global state of the user application is distributed across the plurality of components and managed in a centralized system. Each component of the user application manages its own component states. State information (e.g., global state, component states of individual components) is used to determine a runtime behaviour of the multi-tenant system. A policy resolver communicates with all components impacting the global state of the user application and negotiates with these components for an optimal distribution and balance of underlying resources.

Various embodiments described herein are directed to systems and methods for dynamically supporting a plurality of tenants (e.g., divisions, departments, users, or client organizations) based on respective policy operations associated with respective configurations of a user application in a cloud-based service platform or system. Such a multi-tenant system is associated with a service provider and includes a plurality of individually deployed enterprise class business components (e.g., executors, notifier, controller, orchestrator). The system synergizes across the plurality of components to meet a subscription agreement between the service provider and each tenant. In some embodiments, a synergy among the components of the system is achieved using respective operation policies that are managed in a standard schema for the plurality of tenants. In some embodiments, a tenant of a cloud-based software as a service (SaaS) provides a user-defined performance setting for one or more of: availability, disaster recovery, latency, and multiregional availability, application level preference, and workload that must be supported. Further, in some embodiments, a set of predefined operation policies are provided to a tenant to control the SaaS behavior. At least one of the set of predefined operation policies is selected to enable the user-defined performance setting in the user application. In some embodiments, different tenants of the multi-tenant systems subscribe to different build time SLAs, availabilities, multiregional availabilities, application level preferences, and workloads that must be supported. A cost effective infrastructure is planned based on an associated operation policy of each respective tenant, e.g., by adaptively allocating hardware resources based on the tenant's specific demand.

In some embodiments, a tenant of a cloud-based SaaS provides a user-defined setting for one or more of: availability, disaster recovery, latency, and multiregional availability, application level preference, and workload that must be supported. Further, in some embodiments, a set of predefined operation policies are provided to a tenant to control the SaaS behavior. At least one of the set of predefined operation policies is selected to enable the user-defined performance setting in the user application. In some embodiments, different tenants of the multi-tenant systems subscribe to different settings (e.g., build time SLAs, availabilities, multiregional availabilities, or workloads that must be supported). The multi-tenant system does not penalize high priority jobs as compared to low priority jobs, and becomes more predictable with well-defined SLAs on various architectural measures, which help situations having critical demands. For each of at least a subset of tenants, a cost effective infrastructure is planned based on an associated operation policy of the respective tenant, e.g., by adaptively allocating hardware resources based on a tenant's specific demand.

In various embodiments, a system including a non-transitory memory configured to store instructions thereon and at least one processor is disclosed. The at least one processor is configured to read the instructions to: obtain, from a user, a request associated with a first division in a user application; identify an operation policy associated with a configuration of the user application for the first division, the user application including a plurality of executors configured to provide a plurality of parameters associated with the configuration; based at least in part on the operation policy of the first division, select one of the plurality of executors to respond to the request associated with the first division; execute the user application using the selected one of the plurality of executors to generate a response to the request associated with the first division; and transmit the response to the request associated with the first division to the user. In some embodiments, the request includes identification information of the first division, and the operation policy associated with the configuration is identified based on the identification information of the first division.

In various embodiments, a computer-implemented method is disclosed. The computer-implemented method includes: obtaining, from a user, a request associated with a first division in a user application; identifying an operation policy associated with a configuration of the user application for the first division, the user application including a plurality of executors configured to provide a plurality of parameters associated with the configuration; determining a current parameter associated with the request in the user application; based at least in part on the operation policy of the first division, selecting one of the plurality of executors to respond to the request associated with the first division; executing the user application using the selected one of the plurality of executors to generate a response to the request associated with the first division; and transmitting the response to the request associated with the first division to the user.

In various embodiments, a non-transitory computer readable medium having instructions stored thereon is disclosed. The instructions, when executed by at least one processor, cause at least one device to perform operations including: obtaining, from a user, a request associated with a first division in a user application; identifying an operation policy associated with a configuration of the user application for the first division, the user application including a plurality of executors configured to provide a plurality of parameters associated with the configuration; determining a current parameter associated with the request in the user application; based at least in part on the operation policy of the first division, selecting one of the plurality of executors to respond to the request associated with the first division; executing the user application using the selected one of the plurality of executors to generate a response to the request associated with the first division; and transmitting the response to the request associated with the first division to the user.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

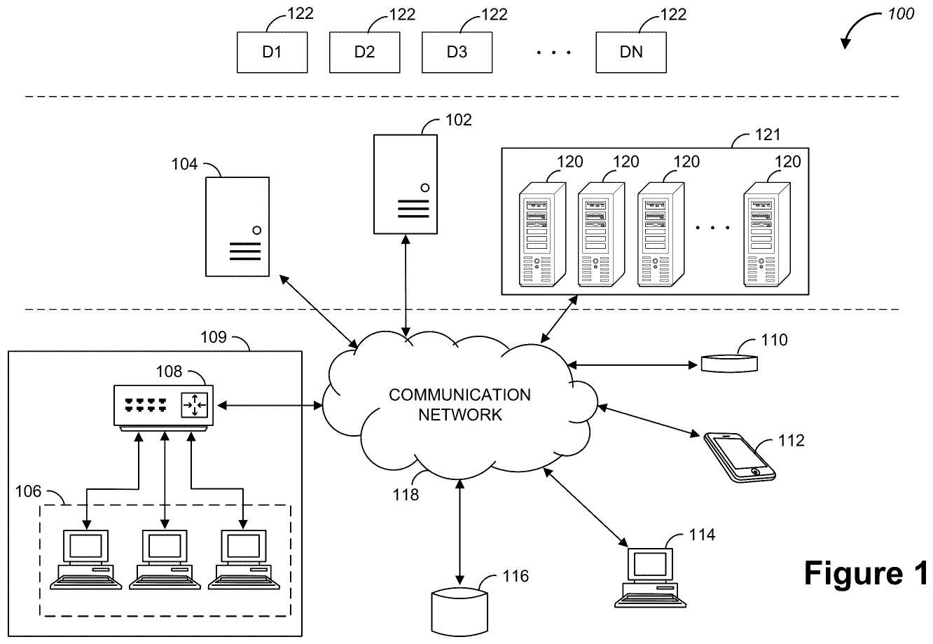

FIG. 1 is a network environment configured to provide a user application (e.g., a shopping application) to a plurality of divisions, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The item recommendation computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the item recommendation computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to item recommendation computing device 102.

Although FIG. 1 illustrates three customer computing devices 110, 112, 114, the network environment 100 can include any number of customer computing devices 110, 112, 114. Similarly, the network environment 100 can include any number of the item recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, the second customer computing device 112, and the Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of the customer computing devices 110, 112, 114 to initiate a web browser that is directed to the website hosted by the web server 104. The customer may, via the web browser, search for items, view item advertisements for items displayed on the website, and click on item advertisements and/or items in the search result, for example. The website may capture these activities as user session data, and transmit the user session data to the item recommendation computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the item recommendation computing device 102.

In some examples, the item recommendation computing device 102 may execute one or more models (e.g., algorithms), such as a machine learning model, deep learning model, statistical model or perform execution of assigned distributed task, etc., to determine recommended items to advertise to the fulfil customer's processing request. (i.e., item recommendations). The item recommendation computing device 102 may transmit the item recommendations, response, outcome to the web server 104 over the communication network 118, and the web server 104 may display one or more of the recommended response/outcome items on the website to the customer. For example, the web server 104 may display the recommended items in response to the customer on a homepage, a catalog webpage, an item webpage, a window or interface of a chatbot, a search results webpage, or a post-transaction webpage of the website (e.g., as the customer browses those respective webpages).

In some examples, the web server 104 transmits a recommendation request to the item recommendation computing device 102. The recommendation request may be a search request sent together with a search query provided by the customer (e.g., via a search bar of the web browser, or via a conversational interface of chatbot), or a standalone recommendation request provided by a processing unit in response to the user's action on the website, e.g. interacting (e.g., engaging, clicking, or viewing) with the response.

In one example, a customer selects an item on a website hosted by the web server 104, e.g. by clicking on the item to view its product description details, by adding it to shopping cart, or by purchasing it. The customer may submit a reference query referring to the selected item, e.g. a query seeking an item similar to the selected item but with one or more different features. In response to receiving the request, the item recommendation computing device 102 may execute the one or more processors to determine some items that include these desired features and are the same as or very close to the selected item. The item recommendation computing device 102 may transmit some or all of the recommended items to the web server 104 to be displayed to the customer.

In another example, a customer submits a first query on a website hosted by the web server 104, e.g. by entering the first query in a search bar of a webpage or a chatbot. The web server 104 may send a first search request to the item recommendation computing device 102. In response to receiving the first search request, the item recommendation computing device 102 may execute the one or more processors to determine search results including items matching the first query, and transmit the search results including recommended items to the web server 104 to be displayed to the customer. The customer may be interested in one item in the search results, but want to twist it a little bit. For example, the customer may click on an image of the item, to submit the image as a reference image, and enter a second query in a search bar of the webpage or the chatbot, where the second query refers to the reference image to seek another item that is similar to the clicked item in the reference image but with one or more different features. The web server 104 may send a second search request to the item recommendation computing device 102. In response to receiving the second search request, the item recommendation computing device 102 may execute the one or more processors to determine recommended items that include these desired features and are the same as or very close to the clicked item in the reference image, and transmit some or all of the recommended items to the web server 104 to be displayed to the customer. This process can go on as the customer may select one of the newly recommended items as a reference and submit a third query associated with the newly selected item, to look for another item.

In yet another example, a customer may upload a reference image of a product and submit a query seeking a similar product but with some conditions, e.g. by entering the query in a search bar of a webpage or a chatbot on a website hosted by the web server 104. The web server 104 may send a search request to the item recommendation computing device 102. In response to receiving the search request, the item recommendation computing device 102 may execute the one or more processors to determine recommended items that meet these conditions and are the same as or very close to the product in the reference image, and transmit some or all of the recommended items to the web server 104 to be displayed to the customer. This process can go on as the customer may select one of the newly recommended items as a reference and submit another query associated with the newly selected item, to look for another item.

The item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store purchase data received from the web server 104 in the database 116. The item recommendation computing device 102 may also receive from the web server 104 user session data identifying events associated with browsing sessions, and may store the user session data in the database 116.

In some examples, the item recommendation computing device 102 generates training data for a plurality of models (e.g., machine learning models, deep learning models, statistical models, algorithms, etc.) based on attribute data, vocabulary data, image data, caption data, historical user session data, search data, purchase data, catalog data, and/or advertisement data for the users. The item recommendation computing device 102 trains the models based on their corresponding training data, and the item recommendation computing device 102 stores the models in a database, such as in the database 116 (e.g., a cloud storage).

The models, when executed by the item recommendation computing device 102, allow the item recommendation computing device 102 to determine item recommendations to be displayed to a customer. For example, the item recommendation computing device 102 may obtain the models from the database 116. The item recommendation computing device 102 may then receive, in real-time from the web server 104, a search request identifying a reference image and an associated query submitted by the customer interacting with a website. In response to receiving the search request, the item recommendation computing device 102 may execute the models to determine recommended items to display to the customer.

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, item recommendation computing device 102 may generate ranked item recommendations for items to be displayed on the website to a user.

In some examples, each of the recommended items is displayed to the customer with a target image representing the recommended item. The recommended items are determined to be best match to a combination the reference image and the submitted query, where their matching scores are beyond a predetermined threshold. When there are multiple recommended items, they may be ranked according to their respective matching scores to form a ranked list of recommended items based on some ranking and filtering models.

In some embodiments, the network environment 100 is configured to provide a user application (e.g., a shopping application) to a plurality of tenants 122. An example of the plurality of tenants 122 is a plurality of independent organizations that subscribes to service provided by the computing devices 102, 104, and 120, and therefore share resources via the network environment 100. Another example of the plurality of tenants 122 is a plurality of divisions or departments (D1-DN) of an organization that provides online and in-store sales of products using the network environment 100. The user application is deployed for the plurality of divisions D1-DN of the organization, and executed to process requests associated with the plurality of divisions D1-DN concurrently in the network environment 100. For example, based on different subscriptions, each of the plurality of tenants 122 optionally defines one or more settings of availability, disaster recovery, latency, multiregional availability, or a workload. Requests associated with the plurality of divisions D1-DN are received from the workstation(s) 106 and the multiple customer computing devices 110, 112 and 114. Resources of the item recommendation computing device 102, the web server 104, and the one or more processing devices 120 are allocated based at least in part on the settings to process the received requests associated with the plurality of divisions D1-DN adaptively.

Stated another way, in some embodiments, the network environment 100 is implemented to enable multitenancy in the user application. This brings down a cost of an IT infrastructure (e.g., hardware, operating system, database) for hosting the user application. The resources of the devices 102, 104, 120, 106, 110, 112, 114, and 120 are shared across the plurality of tenants 122 and associated individual users. Common infrastructure is applied for the plurality of tenants 122 and simplifies management and maintenance of the user application. Such an application-level multitenancy increases a cost efficiency of the user application for the plurality of tenants 122.

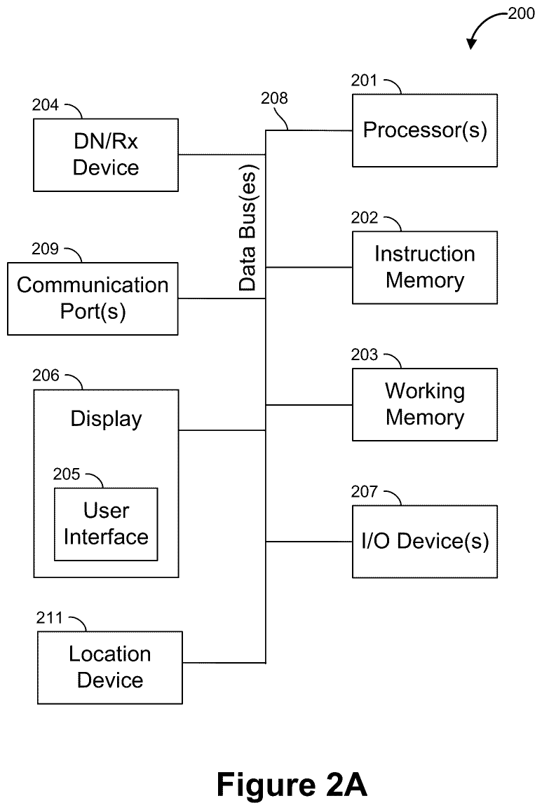

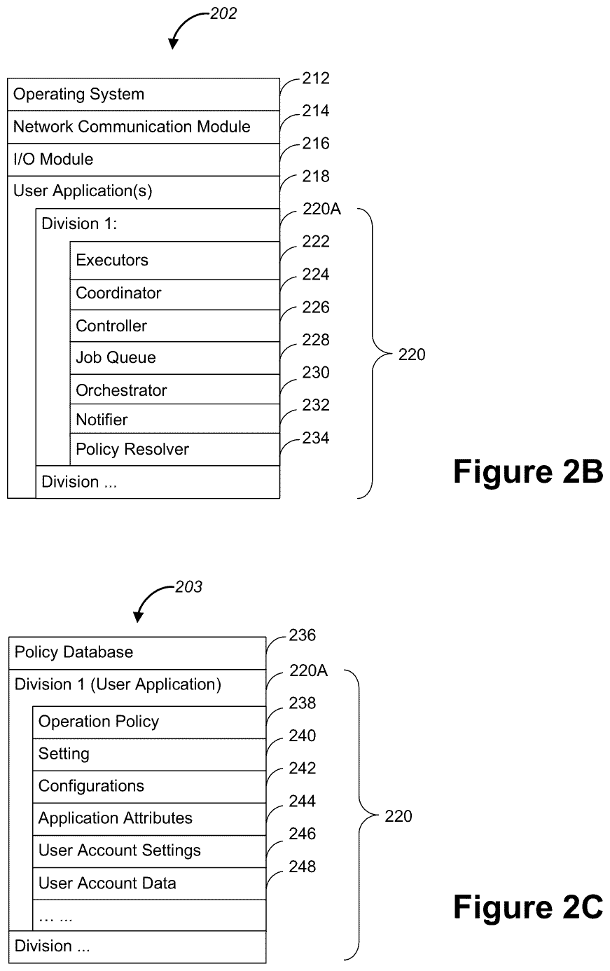

One skilled in the art knows that item recommendation is one of a plurality of functions that are implemented by user applications in a cloud-based multi-tenant system. Each tenant has a plurality of users. A item recommendation user application is deployed for each tenant of the cloud-based multi-tenant system, and implemented to respond to queries received from the plurality of users associated with the respective tenant, e.g., via user interfaces of the deployed item recommendation user application. In some embodiments, a plurality of tenants includes a plurality of divisions 220 (FIG. 2B) of an organization that provides service or products using the network environment 100. For example, the item recommendation user application is deployed for Wal-Mart's five different divisions including Wal-Mart Discount Stores, Wal-Mart Supercenters, and Sam's Club. In some embodiments, a plurality of tenants includes a plurality of independent organizations that subscribes to service provided by the user application 218, and share resources in the network environment 100. For example, the item recommendation user application is deployed for five subscriber small businesses of a large web service company that provides cloud computing services to these five subscriber small businesses.

FIG. 2A is a block diagram of a computing device 200, e.g. the item recommendation computing device 102 of FIG. 1, in accordance with some embodiments of the present teaching, and FIGS. 2B and 2C are structures of instructions and data stored in memory of a computing device 200, in accordance with some embodiments of the present teaching. In some embodiments, each of the item recommendation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the item recommendation computing device 102. It should be appreciated, however, that the elements described can be included, as applicable, in any of the item recommendation computing device 102, the web server 104, the workstation(s) 106, the multiple customer computing devices 110, 112, 114, and the one or more processing devices 120.

As shown in FIG. 2, the item recommendation computing device 102 can include one or more processors 201, a working memory 202, one or more input/output devices 207, an instruction memory 203, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the item recommendation computing device 102. The working memory 202 can be a random access memory (RAM) such as a static random access memory (SRAM) or dynamic random access memory (DRAM), or any other suitable memory.

The input-output devices 207 can include any suitable device that allows for data input or output. For example, the input-output devices 207 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the item recommendation computing device 102. For example, the user interface 205 can be a user interface for an application of a retailer that allows a customer to view and interact with a retailer's website. In some examples, a user can interact with the user interface 205 by engaging the input-output devices 207. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the item recommendation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the item recommendation computing device 102 may determine a local geographical area (e.g., town, city, state, etc.) of its position. Based on the geographical area, the item recommendation computing device 102 may determine relevant trend data (e.g., trend data identifying events in the geographical area).

In some embodiments, the computing device 200 is configured to implement a user application for a plurality of tenants 122 via service deployment, service execution, self-learning and fine tuning, and session knowledge enrichment. Referring to FIG. 2B, in some embodiments, the working memory 202 or alternatively the non-transitory computer readable storage medium of memory 202 stores the following programs, modules and data structures, instructions, or a subset thereof:
Operating system 212 that includes procedures for handling various basic system services and for performing hardware dependent tasks;
Communication module 214 that is used for connecting the computing device 200 to other machines (e.g., other devices 102, 104, 120, 106, 110, 112, 114, and/or 116 in the network environment 100) via one or more network communication ports 209 (wired or wireless) and one or more communication networks 118, such as the Internet, other wide area networks, local area networks, metropolitan area networks, and so on;
I/O module 216 that includes procedures for handling various basic input and output functions through one or more input and output devices; and
User application 218 that is executed to provide server-side functionalities, where an example of the user application 218 is a shopping application selling products to customers of a plurality of divisions 220 (e.g., D1-DN in FIG. 1) based on respective operation policies and configurations.

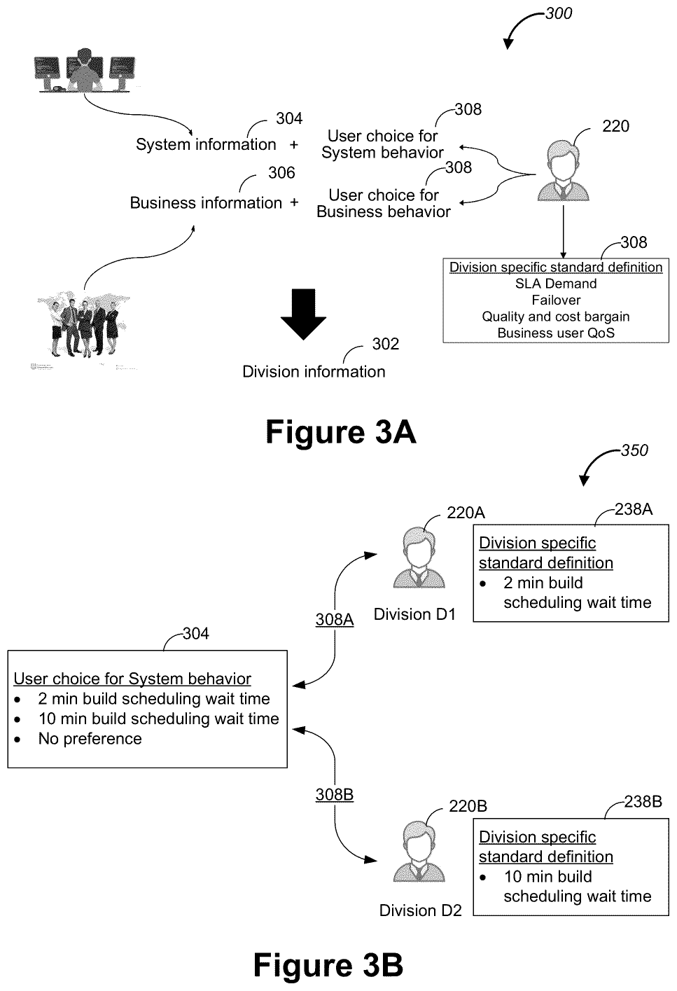

In some embodiments, the user application 218 includes a plurality of components 222-234 configured to provide the server-side functionalities for each of the plurality of divisions 220. For each division 220, the plurality components includes a subset or all of: executor components 222, coordinator component 224, controller component 226, job queue component 228, orchestrator component 230, notifier component 232, and policy resolver 234. Based on each tenant's subscription, a service provider dynamically orchestrates policies 238 and configurations 242 across the plurality of components 222-234 of the user application 218. During execution, a request is received in a user session from a user associated with a certain division 220 (e.g., the first division 220A), and includes an identity of the division 220 used to determine operation of each component involved in processing the request. In some embodiments, the plurality of components 222-234 of the user application 218 adjusts configurations 242 or an operation policy 238 in real time while processing the request received from the user associated with the division 220. Each component enriches the user session, which is used by subsequent component(s) and by a global state to fine tune user experience of the user application 218. More details on each component of the plurality of components 222-234 are explained below with reference to FIGS. 3-8.

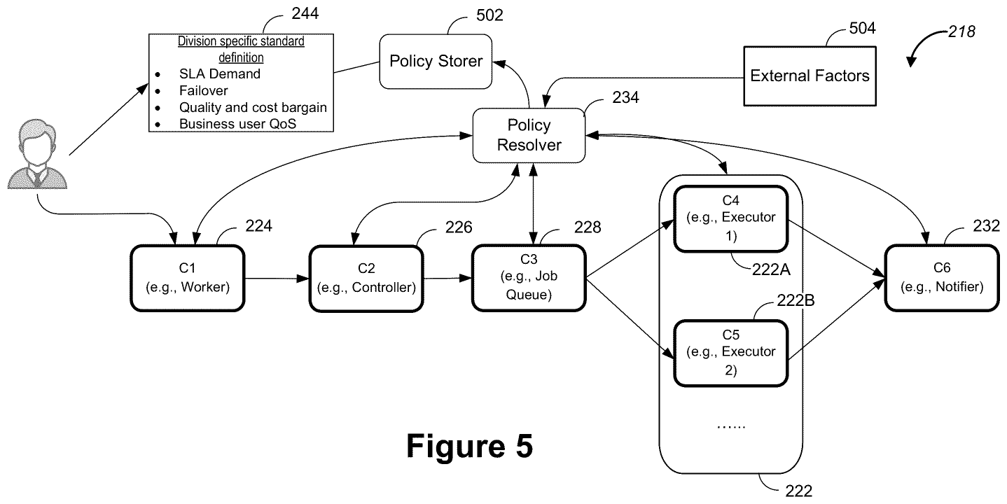

Referring to FIG. 2C, in some embodiments, the working memory 203 stores a policy database 236 for storing respective operation policies 238 in association with a plurality of divisions 220 including the first division 220A based on a schema. In an example, the working memory 203 includes a policy store (e.g., store 502 in FIG. 5) for storing the policy database 236. In some embodiments, for each of the plurality of divisions 220 (e.g., the first division 220A), the working memory 203 stores one or more of: settings 240, configurations 242, application attributions 244, user account settings 246, and user account data 248. Optionally, the respective operation policies 238 are stored separately with associated divisions 220. In some embodiments, the computing device 102 obtains a user input for a user-defined performance setting 240 of the user application 218 associated with the first division 220A. Based on the user-defined performance setting, the operation policy 238 associated with the configuration 242 of the user application 218 is determined and stored for the first division 220A. In some embodiments, while executing the user application 218, automatically and without user intervention, the computing device 200 monitors one or more attributes 244 of the user application 218 for the first division 220A, and adjusts the operation policy 238 of the configuration 242 for the first division 220A based on the monitored attributes 244 of the user application 218. The user account settings 246 include account settings of one or more user accounts of the user application 218 associated with each division 220. The user account data 248 includes data that are generated by the user application 218 for the user accounts associated with each division 220.

FIG. 3A illustrates example sources 300 of division information 302 applied to determine operation policies for each of a plurality of divisions 220, in accordance with some embodiments of the present teaching, and FIG. 3B illustrates an example process 350 of setting operation policies for a plurality of divisions 220, in accordance with some embodiments of the present teaching. A computing device 100 is configured to execute a user application 218 for a plurality of divisions 220 of an organization (also called a service provider). Each division 220 (e.g., a first division 220A) has respective users of the user application 218, and each of the respective users is shared with one of remaining divisions 220 or distinct from users of any remaining division 220. For each division 220, the computing device 100 receives requests from the respective users of the user application 218 and executes the user application 218 according to an operation policy associated with a configuration of the user application 218 to generate responses to the requests. The responses are transmitted to the respective users of the respective division 220.

In some embodiments, in accordance with the operation policy associated with the configuration of the user application 218, resources of the computing device are allocated to process the requests from the respective users of the user application 218 adaptively. For each division 220, the operation policy associated with the configuration of the user application 218 is determined based on the division information 302 including information of the respective division 220. Specifically, in some embodiments, the division information 302 of each division 220 includes the operation policy associated with the configuration of the user application 218. The sources 300 of division information 302 include, but are not limited to, system information 304 of the network environment 100, business information 306 of the user application 218, and one or more user inputs 308 of the system information 304 and the business information 306. In some embodiments, the system information 304 of the network environment 100 includes computational, storage, and communication bandwidths of each device 102, 104, 106, 108, or 120 involved in execution of the user application 218 associated with the respective division 220. In some embodiments, the business information 306 includes consumer demands and expectations collected by a market study.

In an example, the user application 218 includes a retail shopping application. In some situations, a certain division 220 requires an ultra-low latency for using the retail shopping application. All or a subset of product data is cached, such that a response time to a user click on a product page is less than a threshold load time. In some situation, a certain division 220 has a low observability level of a process implemented by the user application 218, and intermediate data and reports are not needed, thereby expediting the process and reducing the latency. In some situations, a certain division 220 has different tiers of users (e.g., preferred users, economic users), and sets different response rates and storage quotas for the different tiers of users. The use application 218 is configured to offer a low latency time (e.g., below a threshold latency time) in response to requests of the preferred customers, while not promising the same low latency time for the economic users. In some embodiments, the preferred users are identified as members, and the economic users are guests. Alternatively, in some embodiments, the division 220 identifies top spenders as its preferred users. Alternatively, in some embodiments, an economic user pays additional fees to become a preferred user. In some situations, each division 220 tolerates a respective failover latency (e.g., 10 milliseconds) due to a failover. In some situations, a certain division 220 prioritizes latency performance over service quality. For example, in response to a product search request, the computing device determines that an accuracy level of a product search reaches a threshold accuracy level of the division 220, and thereby, terminates the product search to keep a low latency time at a price of gaining a higher accuracy level for the product search. In some embodiments, a certain division 220 has different availability requirements in different geographical regions, e.g., a highest response rate for North American users, an intermediate response rate for European users. In some embodiments, a certain division 220 changes its settings (e.g., operation policies, configurations) upon an occurrence of a predefined user action.

In some embodiments, a representative of each division 220 provides the user inputs 308 defining division information 302 for the respective division 220 based on available system information 304 and business information 306. The user inputs 308 identify one or more of: a latency requirement, an overall availability level, a disaster recovery capability, a latency, multiregional availabilities, a workload, a priority rank of latency and quality, a number of user classes, a service tier, and a predefined user action. In an example, the user inputs 308 defines one or more of: a service-level agreement (SLA) demand, a failover rate, a quality and cost bargain, and a quality of service (QOS). Based on the user inputs 308, the computing device 200 selects a subset of the system information 304 and business information 306 of the user application 218 to define operations of each division 220. By these means, configurations 242 and operation policies 238 of each division 220 are customized based on the user inputs 308 (e.g., which select performance setting 240 of the respective division 220), allowing the computing device 200 to allocate sufficient resources to implement user requests associated with the respective division 220 efficiently.

In some embodiments, the computing device 200 obtains a user input 308A for a user-defined performance setting 240 (e.g., “fast response”) of the user application 218 associated with the first division 220A. Based on the user-defined performance setting 240, the computing device 200 determines the division information 302 including the operation policy 238 associated with the configuration of the user application 218 (FIG. 2C) for the first division 220A. For example, the operation policy 238A of the user application 318 is set as “2 minute build scheduling wait time” for the first division 220A. The operation policy 238 is associated with the configuration 242 (e.g., wait time) of the user application 218 and stored in a policy database 236 (FIG. 2C) for the first division 220. The policy database 236 stores a plurality of operation policies 238 for the plurality of divisions 220. Further, in some embodiments, the available system information 304 includes a set of predefined operation policies. The operation policy 238 associated with the configuration for the first division 220A is selected from the set of predefined operation policies of the system information 304 based on the user-defined performance setting 240. In some embodiments, the operation policy 238 stored in the policy database 236 for a second division 220B is “10 minute build scheduling wait time.” The computing device 200 obtains a user input 308B for a user-defined performance setting 240 (e.g., “acceptable”) of the user application 218 associated with the second division 220B. Based on the user-defined performance setting 240, the operation policy 238B associated with the configuration (e.g., “wait time”) of the user application 218 is selected and stored for the second division 220B accordingly.

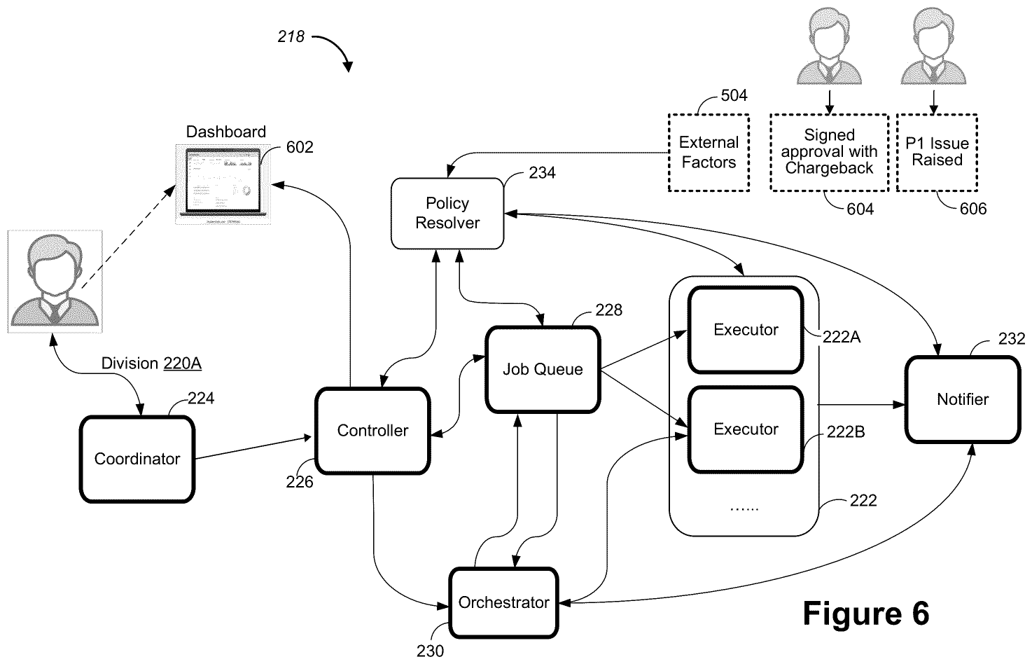

In some embodiments not shown, the computing device 200 enables display of a user interface (FIG. 6, 602) associated with the user application 218 on an electronic device of the first division 220A, which is controlled by the representative of the first division 220A. Based on the first division's subscription, the user interface displays one or more settings (e.g., 3 settings of the system information 304 in FIG. 3B) available to the first division 220A. In some embodiments, the computing device 200 offers one or more shorter wait times than the 2 minute wait time, and however, these shorter wait times are only offered to divisions 220 having a higher subscription class (e.g., paying more service fees, having a high profitability level in the organization). The user input 308A includes the user-defined performance setting 240 of the first division 220A. More specifically, in some embodiments, the user interface displays one or more of: (1) a plurality of distinct setting options (e.g., in the system information 304 in FIG. 3B) from which the user input 308A selects the user-defined performance setting, (2) a setting range in which the user input 308A sets the user-defined performance setting, and (3) a text box for receiving the user input of the user-defined performance setting.

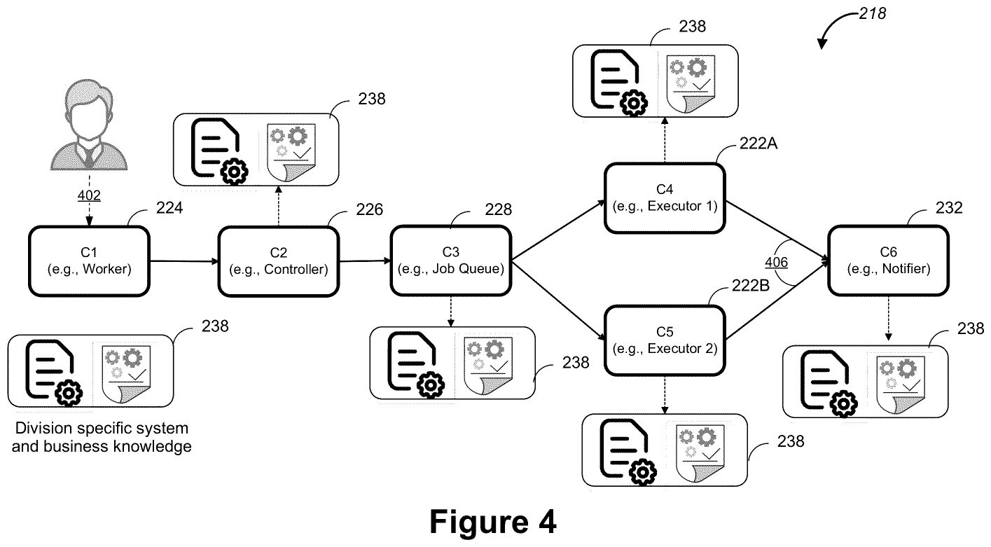

FIG. 4 is a block diagram of an example user application 218 implemented for a plurality of tenants in response to associated requests, in accordance with some embodiments of the present teaching. The user application 218 has a plurality of tenants 122 (FIG. 1). An example of the plurality of tenants 122 is a plurality of independent organizations that subscribes to service provided by the user application 218, and share resources in the network environment 100. Another example of the plurality of tenants 122 is a plurality of divisions 220 (FIG. 2B) of an organization that provides service or products using the network environment 100. The user application 218 is deployed for each of the plurality of divisions 220 of the organization, and executed concurrently for the plurality of divisions 220 in the network environment 100, e.g., in response to requests received from users of individual divisions 220. During execution of the user application 218, the computing device 200 (e.g., a server) obtains, from a user, a request 402 associated with a first division 220A in the user application 218, and identifies an operation policy 238 associated with a configuration of the user application 218 for the first division 220A. In some embodiments, the request includes identification information of the first division 220A, and the operation policy 238 associated with the configuration is identified (e.g., uniquely for the first division 220A) based on the identification information of the first division 220A. The user application 218 includes a plurality of executors 222 (e.g., a first executor 222A, a second executor 222B) configured to provide a plurality of parameters associated with the configuration. For example, the first executor 222A has a higher execution rate than the second executor rate 222B, and a wait time of the operation policy 238 is associated with these execution times. Based at least in part on the operation policy of the first division 220A, the computing device 200 selects one of the plurality of executors 222 (e.g., the first executor 222A) to respond to the request associated with the first division 220A, and executes the user application 218 using the selected one of the plurality of executors 222 to generate a response 404 to the request 402 associated with the first division 220. The response 404 to the request 402 associated with the first division 220 is transmitted to the user (e.g., to a customer computing devices 110, 112, 114 of the user).

In some embodiments, the user application 218 has a plurality of components further including the executors 222 and one or more additional components of: an coordinator component 224, a controller component 226, a job queue component 228, and a notifier 232. In some embodiments, the plurality of components of the user application 218 form an ordered sequence of components configured to execute the user application 218. Each of at least a subset of the plurality of components of the user application 218 operates according to a respective operation policy 238 of a respective configuration (e.g., a conditional allocation of a CPU portion, a conditional priority, a varying upper limit of CPU usage). In some embodiments, the operation policy 238 associated with the configuration is applied to control, for the first division 220A, one or more attributes 244 of the user application 218 selected from: a latency of an individual component, a total latency of a subset of components, an approval process, an error notification, a task priority, a task assignment, a utilization rate of an individual component, a utilization ratio among a subset of components, and a wait time based executor structure.

More specifically, in some embodiments, the coordinator component 224 is configured to receive and preprocess the request 402 from a user of the first division 220A. The controller 226 is coupled to the coordinator component 224, and configured to allocate resources of the computing device 200 to process the request 40 and add the request 402 into a job queue managed by the job queue component 228. The job queue component 228 is configured to manage the request and other tasks in one or more job queues. The executors 222 are managed by the controller 226 to process the request 402 and other tasks in the one or more job queues. In some embodiments, the one of the executors 222 (e.g., the first executor 222A) is selected to process the request 402 based on a respective operation policy 238 of the configuration. Alternatively, in some embodiments, a second executor 222B is selected jointly with the first executor 222A to respond to the request 402 associated with the first division 220A. The first and second executors 222A and 222B apply two respective utilization rates (e.g., 70% and 20%). Alternatively, in some embodiments, while the first executor 222A is selected to process the request 402, the second executor 222B is selected to process a distinct request from a distinct division 220.

In some embodiments, the plurality of components of the user application 218 is configured to communicate with one another directly, e.g., based on the respective operation policies 238. Alternatively, in some embodiments, the user application 218 further includes a policy resolver 234 (FIG. 5) coupled to the plurality of components of the user application 218, and the policy resolver 234 is configured to coordinate operations of the plurality of components of the user application 218 based on operation policies of the plurality components. For example, an operation policy requires that a total latency of a first component (e.g., executor 222A) and a second component (e.g., notifier 232) be below a threshold latency (e.g., 500 milliseconds).

In some situations, a current parameter of the request 402 is determined in real time based on operation of at least a subset of the plurality of components of the user application 218. The one of the executors 222 is selected to respond to the request 402 adaptively based on a current parameter of the request 402 and the operation policy 238 of the first division 220A. For example, the operation policy 238 of the configuration defines a scheduling wait time (e.g., 2 minutes) for the first division 220A. The plurality of parameters associated with the configuration includes execution speeds of the plurality of executors 222 of the user application 218. The current parameter of the request includes a turnaround time between receiving the request 402 and its arrival at the executors 222. The one of the plurality of executors 222 is dynamically selected to respond to the request 402 associated with the first division 220A based on the turnaround time of the request 402 and in compliance with the operation policy of the scheduling wait time. In some situation, in accordance with a determination that the turnaround time of the request 402 is significantly smaller than the scheduling wait time, a low-speed executor 222 is selected to process the request 402. In some situation, in accordance with a determination that the turnaround time of the request 402 is close to the scheduling wait time (e.g., greater than 50% of the scheduling wait time), a high-speed executor 222 is selected to process the request 402.

In some embodiments, at least a subset of the plurality of divisions 220 have respective subscription or membership levels, which determine a plurality of setting options, a setting range, or acceptable inputs. During a service subscription phase, a representative of a division 220 is presented with at least one of: (1) a plurality of distinct setting options from which a user input of the representative selects the user-defined performance setting 240, (2) a setting range in which the user input sets the user-defined performance setting 240, and (3) a text box for receiving the user input of the user-defined performance setting 240 that satisfies the acceptable inputs. By these means, each of the subset of the plurality of divisions 220 shares respective demands and expectations with the computing device 200 (e.g., a server of the user application 218).

In some embodiments, during a service deployment stage, the computing device 200 (e.g., a server of the user application 218) dynamically orchestrates policies 238 and configurations 242 of the plurality of components of the user application 218 based on the user-defined performance setting 240, which is limited by the subscription and membership level of the corresponding division 220. In some embodiments, during a subsequent service execution phase, a request is received from a user of a division 220, and includes identification information of the division 220. During runtime, the identification information of the division 220 is used to decide operation of each of a subset of components (e.g., executor 222A) applied to respond to the requests 402. Operation of each individual component (e.g., executor 222A) also varies when the respective component is applied to respond to different requests from users of different divisions 220A based on respective operation policies 238 of the divisions 220.

FIG. 5 a block diagram of an example user application 218 dynamically implemented by a computing device 200, in accordance with some embodiments of the present teaching. The computing device 200 (e.g., a server) obtains, from a user, a request 402 associated with a first division 220A in the user application 218, and identifies an operation policy 238 associated with a configuration of the user application 218 for the first division 220A. The user application 218 includes a plurality of executors 222 (e.g., a first executor 222A, a second executor 222B) configured to provide a plurality of parameters associated with the configuration. Based at least in part on the operation policy of the first division 220A, the computing device 200 selects one of the plurality of executors 222 (e.g., the first executor 222A) to respond to the request associated with the first division 220A, and executes the user application 218 using the selected one of the plurality of executors 222 to generate a response 404 to the request 402 associated with the first division 220. The response 404 to the request 402 associated with the first division 220 is transmitted to the user (e.g., to a customer computing devices 110, 112, 114 of the user).

In some embodiments, the user application 218 further includes a policy store 502, a policy resolver 234, and a plurality of other components (e.g., coordinator component 224, controller component 226, job queue component 228, and notifier 232). The policy store 502 configured to store a policy database 236 configured to store respective operation policies 238 in association with a plurality of divisions 220 including the first division 220A based on a schema. The policy resolver 234 is configured to extract the operation policies 238 of the plurality components from the policy database 236, and coordinate operations of the plurality of components of the user application 218 based on the extracted operation policies 238 of the plurality components.

In some situations, while executing the user application 218, automatically and without user intervention, the computing device 200 monitors one or more attributes 244 of the user application 218 for the first division 220A. Dynamically and in real time, the computing device 200 (specifically, the policy solver 234) adjusts the operation policy 238 of the configuration for the first division 220A based on the monitored attributes 244 of the user application 218. Further, in some embodiments, the one or more attributes 244 of the user application 218 include one or more of: a SLA demand, a failover rate, a quality and cost bargain, and a QoS.

In some situations, while executing the user application 218, the computing device 200 obtains information of external factors 504 configured to impact operation the user application 218 for the first division 220A. An example external factor 504 includes an approval by authority to provide preferred tenancy experience or matching learning system recommendation to provide premium run time experience. Dynamically and in real time, the computing device 200 (specifically, the policy solver 234) adjusts the operation policy 238 of the configuration for the first division 220A based on the information of external factors 504.

Referring to FIGS. 4 and 5, the user application 218 is executed to provide a multi-tenant service platform and has a plurality components having operations customized individually for different tenants. Such a multi-tenant service platform satisfies differential requirements of different tenants based on tenant subscription, and provides differential experience to associated users of these tenants based on both tenant and user subscriptions. The functional components of the user application 218 are synergized to meet the subscription agreements with the tenant or their associated users. This synergy is achieved using well defined operation policies organized and stored in a policy database 236 according to a schema. The operation policies are loaded at a start or during a run time, and can be dynamically adjusted during the run time. In some situations, self learning modules are used for continual learning and adaption of component operation based on real time application attributes 244.

In some embodiments, the user application 218 has a global state distributed across at least a subset of the plurality of components. Optionally, the global state is maintained in a centralized system. Optionally, copies of the global state are stored and updated locally in each of the subset of components. The global state is used to monitor operation of the user application control configurations or operation policies of the subset of components dynamically. A global state is always centralised, and conversely, component level states are present as local to individual components (e.g., components 222-234 in FIG. 5). Global states and component level states are complementary in nature and not a local copy.

In some embodiments, the user application 218 is executed for a plurality of divisions 220 including the first division 220A based on respective operation policies 238. Dynamically and in real time, based on the respective operation policies 238, the computing device 200 allocates computational, storage, or communication resources to execute the user application 218 for the plurality of divisions 220. By these means a utilization rate of the computing device 200 is enhanced to concurrently support as many divisions 220 as possible.

FIG. 6 a block diagram of an example user application 218 implemented for a first division 220A, in accordance with some embodiments of the present teaching. In some embodiments, the first division 220A has a subscription or membership level, e.g., determined by subscription or membership fees paid by the first division 220A. The subscription or membership level corresponds to a plurality of setting options, a setting range, or acceptable inputs. A user interface 602 is displayed for a representative of the first division 220 by the user application 218, and includes at least one of: (1) a plurality of distinct setting options from which a user input of the representative selects the user-defined performance setting 240, (2) a setting range in which the user input sets the user-defined performance setting 240, and (3) a text box for receiving the user input of the user-defined performance setting 240 that satisfies the acceptable inputs. Stated another way, the user interface 602 displays one or more settings 240 available to the first division 220A. A user input 308 (FIG. 3C) is obtained to select a user-defined performance setting 240 of the first division 220A. Based on the user-defined performance setting 240, the computing device 200 determines an operation policy 238 associated with the configuration of the user application 218 for the first division 220A.

In some embodiments, the user application 218 has a plurality of components further including one or more of: an coordinator component 224, a controller component 226, a job queue component 228, a plurality of executors 222 and a notifier 232. The coordinator component 224 is configured to receive and preprocess a request 402 from a user associated with a division 220. The controller 226 is coupled to the coordinator component 224, and configured to allocate resources of the computing device 200 to process the request 40 and add the request 402 into a job queue managed by the job queue component 228. The job queue component 228 is configured to manage the request and other tasks in one or more job queues. The executors 222 are managed by the controller 226 to process the request 402 and other tasks in the one or more job queues. The notifier 232 is configured t to provide a response 404 to the request 402. Further, in some embodiments, the plurality of components of the user application 218 further includes an orchestrator 230 configured to inform a job queue component 228 of an executor 222 being newly made available or being made unavailable.

For each division 220, each component in a user session enriches the user session, and is used by one or more remaining components or a global state to fine tune user experience of using the user application 218. The plurality of components of the user application 218 share information with one another to adjust operations of the components in real time to satisfy the operation policy 238, which is determined based on the user-defined performance setting 240 entered by a representative of the respective division 220. By these means, the user application 218 fine tunes the plurality of components and enables the user-defined performance setting 240 to users of the respective division 220. In some embodiments, a state of an overall system includes a global state, a component level state, or a combination thereof. The global state is application for run time information which involves multiple components like SLA for end-to-end execution of a user application in response to a request. The global state controls an execution state of the overall system

In some embodiments, the user application 218 obtains at least one of an external factor 504 and a division approval 604 based on the operation policy 238 of the configuration of the first division 220A. The one of the plurality of executors 222 is selected to respond to the request 402 associated with the first division 220A based on the at least one of the external factor 504 and the division approval 604. For example, the division approval includes a chargeback approval. A representative of the first division 220A has to grant the chargeback approval when a demand is received from a credit-card provider for the user application 218 to make good a loss on a fraudulent or disputed transaction. In response to the operation policy 238 of the configuration of the first division 220A, the policy resolver 234 is configured to interrupt a process flow for a chargeback request and arrange the chargeback approval for the chargeback request. In another example, a representative of the first division 220A raises an issue 606. In response to an operation policy 238 of the configuration of the first division 220A, the policy resolver 234 is configured to interrupt a process flow for the request 402, determines whether the raised issue 606 exists, and continue the process flow in accordance with a determination that the raised issue 606 does not exist or has been addressed.

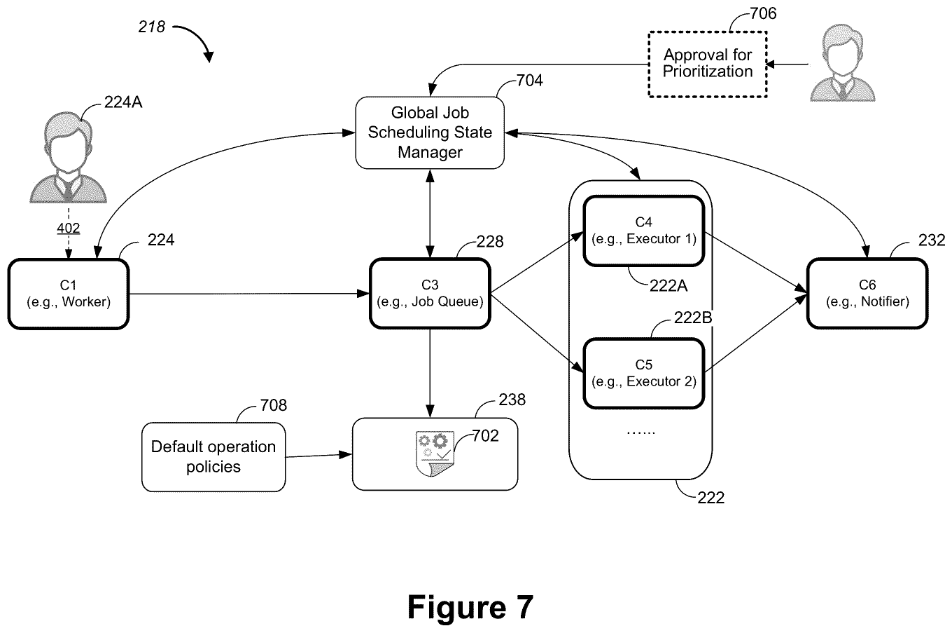

FIG. 7 a block diagram of an example user application 218 implemented with scheduling management for a first division 220A, in accordance with some embodiments of the present teaching. In some embodiments, a user application 218 has a plurality of components further including one or more of: an coordinator component 224, a job queue component 228, a plurality of executors 222 and a notifier 232. The coordinator component 224 is configured to receive and preprocess a request 402 from a user associated with a division 220. The job queue component 228 is configured to manage the request and other tasks in one or more job queues. The executors 222 are managed by the controller 226 to process the request 402 and other tasks in the one or more job queues. The notifier 232 is configured t to provide a response 404 to the request 402.

In some embodiments, a job queue managed by the job queue component 228 includes a plurality of requests arranged in a temporally-ordered sequence of requests. In some situations, the plurality of requests are received from one or more users of a division (e.g., the first division 220A). Alternatively, in some embodiments, the plurality of requests are received from users of two or more divisions (e.g., including the first division 220A). An operation policy 238 is associated with the job queue component 228 and includes one or more job scheduling preferences 702 of the first division 220A. In some embodiments, the operation policy 238 including the job scheduling preference(s) 702 is received from a representative of the first division 220 during a service subscription phase. The user application 218 further includes a global job scheduling state manager 704. In some embodiments, the global job scheduling state manager 704 assigns each request associated with the first division 220A to a respective executor 222 identified by a corresponding job scheduling preference 702, and in some situations, this request assignment is based on availability of the respective executor 222 and job scheduling preferences of other divisions.

In some embodiments, the global job scheduling state manager 704 is configured to identify a subset of the requests in the plurality of requests in the job queue and change an order of each of the subset of the requests based on the one or more job scheduling preferences 702. One or more requests are optionally prioritized over remaining requests. Further, in some situations, the operation policy 238 includes a real-time approval 706 for a change of an order of one of the subset of the requests, e.g., based on a type of the one of the subset of the requests. The global job scheduling state manager 704 communicates with a representative of the first division 220A to obtain the real-time approval for the change of the order of the subset of the requests in the job queue managed by the job queue component 228.

In some embodiments, one of the plurality of executors (e.g., a first executor 222A) is selected to process a request 402. Based at least in part on the operation policy 238 of the first division 220A, the user application 218 selects a second executor 222B jointly with the first executor 222A to respond to the request 402 associated with the first division 220A, and applies two respective utilization rates (e.g., 70% and 20%) for the first and second executors.

In some embodiments, the user application is associated with a plurality of divisions 220. For each of the plurality of divisions 220, the computing device 200 automatically applies one or more default operation policies 708 associated with one or more default configurations to the user application 218 deployed for the respective division 220. Further, in some embodiments, the plurality of divisions includes the first division 220A, and the computing device 200 preempts the operation policy 238 associated with the configuration over the one or more default operation policies for the first division 220A.

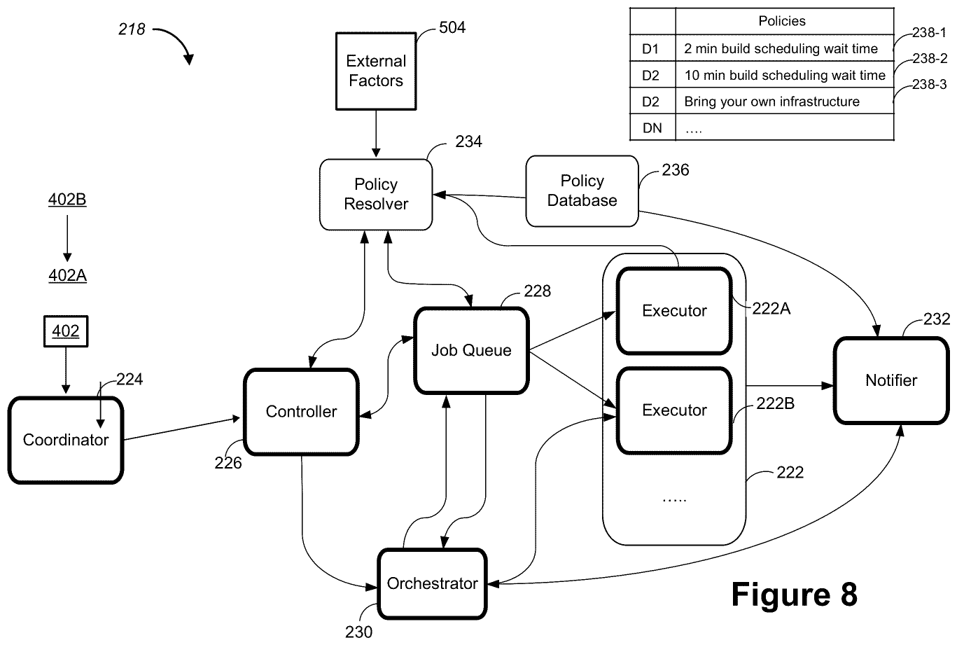

FIG. 8 a block diagram of an example user application 218 implemented for two divisions 220A (D1) and 220B (D2) based on different current parameters or operation policies 238 of the two divisions 220A and 220B, in accordance with some embodiments of the present teaching. In some embodiments, the computing device 200 determines a current parameter associated with a request in the user application 218, and one of the plurality of executors 222 is selected adaptively based at least in part on the current parameter of the request and the operation policy 238 of the first division 220A. In an example, the operation policy 238 of the configuration defines a scheduling wait time 238-1 (e.g., 2 minutes) for the first division 220A. A plurality of parameters associated with the configuration includes execution speeds of the plurality of executors 222 (e.g., 222A and 222B) of the user application 218. The current parameter of the request includes a turnaround time between receiving the request 402 and its arrival at the executors 222. The one of the plurality of executors 222 is dynamically selected to respond to the request 402 associated with the first division 220A based on the turnaround time of the request 402 and in compliance with the operation policy 238 of the scheduling wait time.

In some situations, the turnaround time is 12 seconds, which is significantly lower than the scheduling wait time 238-1 (e.g., lower than 20% of the scheduling waiting time 238-1). Time remaining to process the request 402 is significant for the executors 222. The first executor 222A has a lower execution speed than the second executor 222B, and is selected to process the request 402. Alternatively, in some situations, the turnaround time is 62 seconds, which is not significantly lower than the scheduling wait time 238-1 (e.g., higher than 50% of the scheduling waiting time 238-1). Time remaining to process the request 402 is limited for the executors 222. The second executor 222B has a higher execution speed than the first executor 222A, and therefore, is selected to process the request 402.

In some embodiments, the user application 218 further includes one or more additional components of: an coordinator component 224, a controller component 226, a job queue component 228, an orchestrator component 230, a notifier 232, and a policy resolver 234. In some situations, a current parameter of the request is determined based on operation of at least a subset of the one or more additional components. In some circumstances, the executors 222 and one or more additional components are configured to directly communicate with one another based on respective operation policies 238. Alternatively, in some circumstances, the policy resolver 234 is coupled to the executors 222 and remaining components 224-232 of the one or more additional components. The policy resolver 234 is configured to coordinate activities of the executors 222 and remaining components 224-232 based on respective operation policies 238. For example, the one or more operation policies 238 includes a first operation policy requiring that a total latency of a first component 220A and a second component 220B be below a threshold latency (e.g., 500 milliseconds).

Further, in some embodiments, the selected one of the plurality of executors includes a first executor 220A, and the request 402 includes a first request. A current parameter of a second request 402B associated with a second division 220B is equal to the current parameter of the first request. Based at least in part on the current parameter of the second request and an operation policy of a second division, the computing device 200 selects a second executor 220B distinct from the first executor 220A to respond to the second request 402B associated with the second division 220B. For example, the operation policy 238 of the configuration defines a scheduling wait time 238-2 (e.g., 10 minutes) for the second division 220B. In some embodiments, the second division 220B has one or more additional operation policies (e.g., “bring your own infrastructure” 238-3). In some situations, the turnaround time is also 62 seconds based on operations of one or more remaining components 224-232, which is significantly lower than the scheduling wait time 238-2 (e.g., lower than 20% of the scheduling waiting time 238-2), and time remaining to process the request 402B is significant for the executors 222. For the second division 220B, the first executor 222A is selected to process the request 402. Alternatively, in some situations, the turnaround time is 342 seconds, which is not significantly lower than the scheduling wait time 238-2 (e.g., higher than 50% of the scheduling waiting time 238-2). Time remaining to process the request 402B is limited for the executors 222. The second executor 222B has a higher execution speed than the first executor 222A, and therefore, is selected to process the request 402.

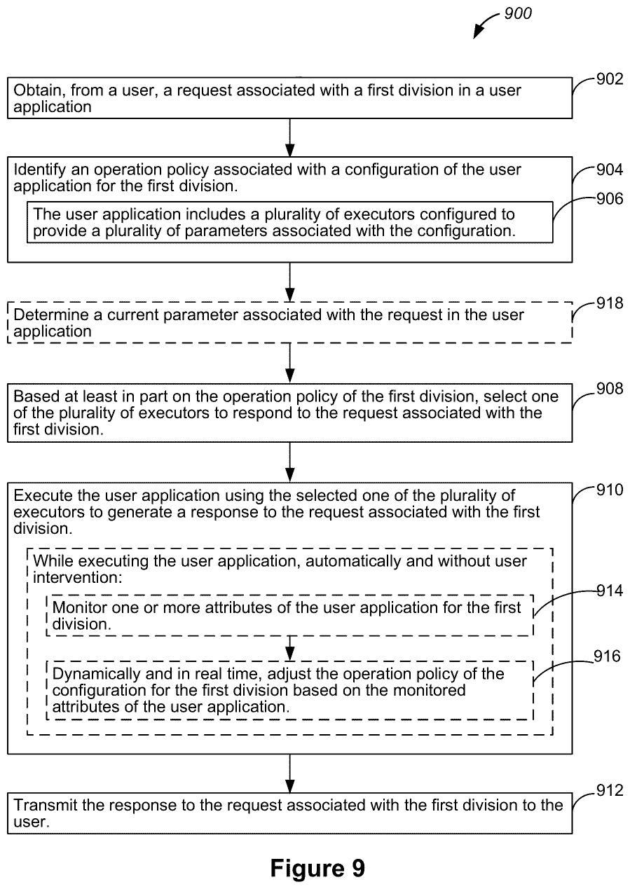

FIG. 9 is a flowchart illustrating an example method 900 for executing a user application for a plurality of divisions based on respective operation policies, in accordance with some embodiments of the present teaching. Method 900 is, optionally, governed by instructions that are stored in a non-transitory computer readable storage medium and that are executed by one or more processors of a system (e.g., including a computing device 200). Each of the operations shown in FIG. 9 may correspond to instructions stored in a computer memory or non-transitory computer readable storage medium (e.g., memory 202 in FIG. 2A). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1100 may be combined and/or the order of some operations may be changed.

Method 900 is performed by a system (e.g., a computing device 200), e.g., during a service execution phase. The system obtains (902), from a user, a request 402 associated with a first division 220A in a user application 218, and identifies (904) an operation policy 238 associated with a configuration of the user application 218 for the first division 220A. The user application 218 includes (906) a plurality of executors 222 configured to provide a plurality of parameters associated with the configuration. Based at least in part on the operation policy 238 of the first division 220A, the system selects (908) one of the plurality of executors 222 to respond to the request 402 associated with the first division 220A. The system executes (910) the user application 218 using the selected one of the plurality of executors 222 to generate a response 404 to the request 402 associated with the first division 220A, and transmits (912) the response 404 to the request 402 associated with the first division 220A to the user. In some embodiments, the request includes identification information of the first division 220A, and the operation policy 238 associated with the configuration is identified (e.g., uniquely for the first division 220A) based on the identification information of the first division 220A. More details on service execution have been explained above with reference to at least FIGS. 3-8.

In some embodiments, while executing the user application 218, automatically and without user intervention, the system monitors one or more attributes 244 of the user application 218 (FIG. 5) for the first division 220A, and dynamically and in real time, adjusts the operation policy 238 of the configuration for the first division 220A based on the monitored attributes 244 of the user application 218. Further, in some embodiments, the one or more attributes 244 of the user application 218 include one or more of: a service-level agreement (SLA) demand, a failover rate, a quality and cost bargain, and a quality of service (QOS).

In some embodiments, the system further includes a policy store 502 (FIG. 5) configured to store a policy database 236. The system stores, in the policy database 236, respective operation policies in association with a plurality of divisions 220 including the first division 220A based on a schema. The operation policy 238 associated with the configuration is stored in association with the first division 220A.

In some embodiments, the user application 218 is associated with a plurality of divisions 220 including the first division 220A. The system obtains a user input 308 (FIG. 3) for a user-defined performance setting 240 of the user application 218 associated with the first division 220A. Based on the user-defined performance setting 240, the system determines the operation policy 238 associated with the configuration of the user application 218 for the first division 220A. The system stores, in a policy database 236, the operation policy 238 associated with the configuration of the user application 218 for the first division 220A, and the policy database 236 stores a plurality of operation policies for the plurality of divisions 220. Further, in some embodiments, the system determine the operation policy 238 for the first division 220A by selecting the operation policy 238 associated with the configuration from a set of predefined operation policies based on the user-defined performance setting 240. Additionally, in some embodiments, the system obtain the user input 308 by enabling display of a user interface 602 (FIG. 6) associated with the user application 218 on an electronic device of the first division 220A; based on the first division's subscription, displaying on the user interface 602 one or more settings available to the first division 220A; and receiving the user input including the user-defined performance setting. In some embodiments, the user interface displays one or more of: (1) a plurality of distinct setting options from which the user input selects the user-defined performance setting 240, (2) a setting range in which the user input sets the user-defined performance setting 240, and (3) a text box for receiving the user input of the user-defined performance setting 240.

In some embodiments, the configuration of the user application 218 includes one or more of: an overall availability level, a disaster recovery capability, a latency, multiregional availabilities, a workload, a priority rank of latency and quality, a number of user classes, a service tier, and a predefined user action.

In some embodiments, the operation policy 238 associated with the configuration is applied to control, for the first division 220A, one or more attributes of the user application 218 selected from: a latency of an individual component, a total latency of a subset of components, an approval process, an error notification, a task priority, a task assignment, a utilization rate of an individual component, a utilization ratio among a subset of components, and a wait time based executor structure.

In some embodiments, the system determines a current parameter associated with the request 402 in the user application 218, and the one of the plurality of executors 222 is selected adaptively based at least in part on the current parameter of the request 402 and the operation policy 238 of the first division 220A. In an example, the operation policy 238 of the configuration defines a scheduling wait time (e.g., 2 minutes) for the first division 220A. The plurality of parameters associated with the configuration includes execution speeds of the plurality of executors 222 of the user application 218. The current parameter of the request 402 includes a turnaround time. The one of the plurality of executors 222 is dynamically selected to respond to the request 402 associated with the first division 220A based on the turnaround time of the request 402 and in compliance with the operation policy 238 of the scheduling wait time.

In some embodiments, the user application 218 further includes one or more additional components of: an coordinator component 224, a controller component 226, a job queue component 228, an orchestrator component 230, a notifier 232, and a policy resolver 234. In some situations, a current parameter of the request 402 is determined based on operation of at least a subset of the one or more additional components. In some circumstances, the executors 222 and one or more additional components are configured to directly communicate with one another based on respective operation policies. Alternatively, in some circumstances, the policy resolver 234 is coupled to the executors 222 and remaining components of the one or more additional components. The policy resolver 234 is configured to coordinate activities of the executors 222 and remaining components. based on respective operation policies. For example, the one or more operation policies includes a first operation policy 238 requiring that a total latency of a first component and a second component be below a threshold latency (e.g., 500 milliseconds).

Further, in some embodiments, the selected one of the plurality of executors 222 includes a first executor 222a, and the request 402 includes a first request 402A. A current parameter of a second request 402B associated with a second division 220B is equal to the current parameter of the first request. Based at least in part on the current parameter of the second request and an operation policy 238 of a second division 220B, the system selects a second executor 222B distinct from the first executor 222A to respond to the second request 402B associated with the second division 220B.

In some embodiments, the selected one of the plurality of executors 222 includes a first executor 222A. Based at least in part on the operation policy 238 of the first division 220A, the system selects a second executor 222B jointly with the first executor 222A to respond to the request 402 associated with the first division 220A, and applies two respective utilization rates for the first and second executors 222A and 222B.

In some embodiments, the user application 218 is associated with a plurality of divisions 220. For each of the plurality of divisions 220, the system automatically applies one or more default operation policies 708 (FIG. 7) associated with one or more default configurations to the user application 218 deployed for the respective division 220. Further, in some embodiments, the plurality of divisions 220 includes the first division 220A, and the system preempts the operation policy 238 associated with the configuration over the one or more default operation policies 708 for the first division 220A.

In some embodiments, the system obtains at least one of an external factor and a division approval. The one of the plurality of executors 222 is selected to respond to the request 402 associated with the first division 220A based on the at least one of the external factor and the division approval.

In some embodiments, the user application 218 is executed for a plurality of divisions 220 including the first division 220A based on respective operation policies. Dynamically and in real time, based on the respective operation policies, the system allocates computational, storage, and communication resources of the system to execute the user application 218 for the plurality of divisions 220. By these means a utilization rate of the system is enhanced to concurrently support as many divisions 220 as possible.

It should be understood that the particular order in which the operations in FIG. 9 have been described are merely example and are not intended to indicate that the described order is the only order in which the operations could be performed. One of ordinary skill in the art would recognize various ways to cache and distribute specific data as described herein. Additionally, it should be noted that details of other processes described herein with respect to FIGS. 4-8 are also applicable in an analogous manner to method 900 described above with respect to FIG. 9. For brevity, these details are not repeated here.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
obtain, from a user, a request associated with a first division in a user application;
identify an operation policy associated with a configuration of the user application for the first division, the user application including a plurality of executors configured to provide a plurality of parameters associated with the configuration;
based at least in part on the operation policy of the first division, select one of the plurality of executors to respond to the request associated with the first division;
execute the user application using the selected one of the plurality of executors to generate a response to the request associated with the first division; and
transmit the response to the request associated with the first division to the user.

2. The system of claim 1, wherein the processor is configured to:
monitor the plurality of parameters associated with the configuration;
based on a change in the plurality of parameters, adjust the operation policy associated with the configuration of the user application for the first division, the adjustment reallocating at least one of:
a plurality of computational resources;
a plurality of storage resources; and
a plurality of communication resources.

3. The system of claim 1, wherein the processor is configured to:
obtain, from the user, a performance setting, wherein the performance setting identifies the operation policy associated with the configuration of the user application for the first division, wherein the plurality of executors are identified based at least in part on the performance setting;
identify a subscription status associated with the user, wherein the subscription status associated with the user identifies a plurality of available executors from the plurality of executors; and
select one of the plurality of available executors to respond to the request associated with the first division.

4. The system of claim 1, wherein the processor is configured to:
identify a subscription status associated with the user, wherein the subscription status associated with the user identifies a plurality of available executors from the plurality of executors;
offer, to the user, a plurality of wait times:
the plurality of wait times are associated with the first division;
the plurality of wait times are set by the operation policy; and
the plurality of wait times are offered based on the subscription status associated with the user;
obtain, from the user, a selected wait time in the plurality of wait times; and
based at least in part on the selected wait time, select one of the plurality of available executors to respond to the request associated with the first division.

5. The system of claim 1, wherein the processor is configured to:
based at least in part on the operation policy of the first division, select a second executor in the plurality of executors to respond to the request associated with the first division; and
execute the user application using the selected one of the plurality of executors and the second executor in the plurality of executors to generate a response to the request associated with the first division, wherein the selected one of the plurality of executors applies a first utilization rate and the second executor in the plurality of executors applies a second utilization rate, the first utilization rate being different from the second utilization rate.

6. The system of claim 1, wherein the processor is configured to:
obtain, from the user, a reference image, the reference image representing a product;
obtain, from the user, a query, the query comprising:
a string representing the product; and
a set of conditions;
determine a set of recommended items based on a matching score, the matching score determined by the string representing the product and the reference image, wherein each item in the set of recommended items:
fulfills the set of conditions;
has an item matching score; and
the item matching score is above a predetermined threshold; and
transmit, to the user, the set of recommended items.

7. The system of claim 6, wherein the set of recommended items are transmitted to the user based on the item matching score of each item in the set of recommended items.

8. The system of claim 1, wherein the processor is configured to:
interrupt the execution of the user application;
send, to a representative, a request to determine a raised issue; and
receive, from the representative, an approval to resume the execution of the user application.

9. The system of claim 1, wherein the processor is configured to:
interrupt the execution of the user application;
send, to a representative, a request to determine a raised issue;
receive, from the representative, a denial to resume the execution of the user application; and
terminate the execution of the user application.

10. The system of claim 1, wherein the processor is configured to:
maintain a job queue, wherein the job queue lists a plurality of requests;
identify, from the operation policy, a job scheduling preference of the first division; and
change the order of requests in the plurality of requests based on the job scheduling preference.

11. The system of claim 1, wherein the processor is configured to:
identify a turnaround time, wherein the turnaround time is one of the parameters in the plurality of parameters associated with the configuration; and
based at least in part on the turnaround time, select one of the plurality of executors to respond to the request associated with the first division.

12. The system of claim 11, wherein the processor is configured to:
determine that the turnaround time is less than a scheduled wait time; and
based at least in part on the determination that the turnaround time is less than the scheduled wait time, select one of the plurality of executors to respond to the request associated with the first division.

13. A computer-implemented method, comprising:
obtaining, from a user, a request associated with a first division in a user application;
identifying an operation policy associated with a configuration of the user application for the first division, the user application including a plurality of executors configured to provide a plurality of parameters associated with the configuration;
based at least in part on the operation policy of the first division, selecting one of the plurality of executors to respond to the request associated with the first division;
executing the user application using the selected one of the plurality of executors to generate a response to the request associated with the first division; and
transmitting the response to the request associated with the first division to the user.

14. The method of claim 13, further comprising:
monitoring the plurality of parameters associated with the configuration;
based on a change in the plurality of parameters, adjusting the operation policy associated with the configuration of the user application for the first division, the adjustment reallocating at least one of:
a plurality of computational resources;
a plurality of storage resources; and
a plurality of communication resources.

15. The method of claim 13, further comprising:
obtaining, from the user, a performance setting, wherein the performance setting identifies the operation policy associated with the configuration of the user application for the first division, wherein the plurality of executors are identified based at least in part on the performance setting;
identifying a subscription status associated with the user, wherein the subscription status associated with the user identifies a plurality of available executors from the plurality of executors; and
selecting one of the plurality of available executors to respond to the request associated with the first division.

16. The method of claim 13, further comprising:
obtaining, from the user, a reference image, the reference image representing a product;
obtaining, from the user, a query, the query comprising:
a string representing the product; and
a set of conditions;
determining a set of recommended items based on a matching score, the matching score determined by the string representing the product and the reference image, wherein each item in the set of recommended items:
fulfills the set of conditions;
has an item matching score; and
the item matching score is above a predetermined threshold; and
transmitting, to the user, the set of recommended items.

17. A non-transitory computer readable medium having instructions stored thereon, wherein the instructions, when executed by at least one processor, cause at least one device to perform operations comprising:
obtaining, from a user, a request associated with a first division in a user application;
identifying an operation policy associated with a configuration of the user application for the first division, the user application including a plurality of executors configured to provide a plurality of parameters associated with the configuration;
based at least in part on the operation policy of the first division, selecting one of the plurality of executors to respond to the request associated with the first division;
executing the user application using the selected one of the plurality of executors to generate a response to the request associated with the first division; and
transmitting the response to the request associated with the first division to the user.

18. The non-transitory computer readable medium of claim 17, further comprising instructions stored thereon that, when executed by at least one processor, further cause the device to perform operations comprising:
monitoring the plurality of parameters associated with the configuration;
based on a change in the plurality of parameters, adjusting the operation policy associated with the configuration of the user application for the first division, the adjustment reallocating at least one of:
a plurality of computational resources;
a plurality of storage resources; and
a plurality of communication resources.

19. The non-transitory computer readable medium of claim 17, further comprising instructions stored thereon that, when executed by at least one processor, further cause the device to perform operations comprising:
obtaining, from the user, a performance setting, wherein the performance setting identifies the operation policy associated with the configuration of the user application for the first division, wherein the plurality of executors are identified based at least in part on the performance setting;
identifying a subscription status associated with the user, wherein the subscription status associated with the user identifies a plurality of available executors from the plurality of executors; and
selecting one of the plurality of available executors to respond to the request associated with the first division.

20. The non-transitory computer readable medium of claim 17, further comprising instructions stored thereon that, when executed by at least one processor, further cause the device to perform operations comprising:
obtaining, from the user, a reference image, the reference image representing a product;
obtaining, from the user, a query, the query comprising:
a string representing the product; and
a set of conditions;
determining a set of recommended items based on a matching score, the matching score determined by the string representing the product and the reference image, wherein each item in the set of recommended items:
fulfills the set of conditions;
has an item matching score; and
the item matching score is above a predetermined threshold; and
transmitting, to the user, the set of recommended items.
